(19) United States
(12) Patent Application Publication
(10) Pub. No.: US 2021/0381920 A1
(43) Pub. Date: Dec. 9, 2021

(54) METHOD OF DETECTING LEAKAGE FROM A PIPELINE

(71) Applicant: UNIVERSITY OF PRETORIA, Pretoria (ZA)

(72) Inventors: Schalk Willem JACOBSZ, Centurion (ZA); Ingo Sebastian JAHNKE, Pretoria (ZA)

(73) Assignee: UNIVERSITY OF PRETORIA, Pretoria (ZA)

(21) Appl. No.: 17/406,563

(22) Filed: Aug. 19, 2021

Related U.S. Application Data
(63) Continuation of application No. PCT/IB2020/051331, filed on Feb. 18, 2020.

(30) Foreign Application Priority Data
Feb. 19, 2019 (ZA) 201901045

(51) Int. Cl. G01M 3/04; G01B 11/16; G02B 6/44

(52) U.S. Cl. CPC G01M 3/047; G02B 6/4471; G01B 11/16

(57) ABSTRACT

The invention provides a method of and an arrangement for detecting leakage from a pipeline installed in a substrate. The arrangement includes a fibre-optic cable positioned in the substrate in the vicinity of the pipeline and a strain monitoring arrangement configured to monitor the strain in the fibre-optic cable and to detect localized changes in the monitored strain. A processor is provided to which the strain monitoring arrangement is connected and which is configured to determine whether the detected change in strain is indicative of a leak in the pipeline and to generate a signal in response thereto.

### CROSS REFERENCE TO RELATED APPLICATIONS

This application claims priority benefit from International Application No. PCT/IB2020/051331 filed on Feb. 18, 2020, which claims priority from South African Application No. 2019/01045 filed on Feb. 19, 2019, each of which are incorporated herein by reference in their entireties.

### FIELD OF INVENTION

This invention relates to the detection of leakage from a pipeline. More particularly it relates to a method of detecting leakage from a pipeline and to a leak detection arrangement.

### BACKGROUND OF THE INVENTION

The loss of water, e.g., as a result of leakage from pipelines, is a serious problem.

In an arid country such as South Africa with a fast-growing population and a rapid trend to urbanisation, the loss of potable water is a major problem both from a capacity and a cost perspective.

Physical losses due to leakage not only cause financial loss to water suppliers and governing bodies, but also pose environmental and health risks.

Another problem is that contaminated surface water can enter a potable water pipeline through leaks during certain operational conditions when low pressures are present in the pipeline and the ambient pressure is above the pressure in the pipeline.

A further problem associated with water leaks from pipelines is the formation of sinkholes. In the Tshwane area of South Africa, it has been reported by Buttrick & Van Schalkwyk (1998) that 98.9% of all new sinkholes are triggered by leaking water pipes, either from the distribution network or from the waste water system. This naturally poses a major risk to all types of infrastructure as well as to the physical safety of the inhabitants.

Naturally, in order to reduce the losses and risks associated with leakage from pipelines it is important to detect a leak at the earliest possible time.

Current leak detection methods include field inspection, mass balance methods, thermal imagery, acoustic methods, ground penetrating radar and satellite interferometry. A disadvantage with many of the known methods is that they require excursion into the field which has both cost and time implications. In addition, the success of certain of the prior art methods may be dependent on the leaking fluid being visible from the surface which is not always the case.

It is an object of the invention to provide means which the Inventors believe will facilitate the early detection of leakage from a pipeline.

### SUMMARY OF THE INVENTION

According to one aspect of the invention, there is provided a method of detecting leakage in a pipeline installed in a substrate, which includes the steps of:

a. monitoring the strain in a fibre-optic cable positioned in the substrate in the vicinity of the pipeline;
b. detecting a localised change in strain; and
c. generating an alert signal if the detected change in strain is indicative of a leak from the pipeline.

The method may include comparing the detected change in strain with a base strain and generating the alert signal if the difference between the detected strain and the base strain exceeds a predetermined level. The base strain may be a baseline strain profile which is pre-recorded. The baseline strain profile may take account of variations, e.g., seasonal variations and the like. Accordingly, the method may include updating the baseline stain profile periodically, to take into account the most recently recorded strain profile.

The substrate may be a particulate material, typically unsaturated soil.

In the context of this specification, the term “unsaturated soil” refers to soil which is either completely dry or in which void spaces between particles are partially filled with water, but not completely. Hence, a leak from a pipe will cause a change in moisture content in the soil which in turn will result in a detectable change in strain in the fibre-optic cable. In this regard, the choice of cable is selected such that the cable is sufficiently deformable so that it can be deformed by the soil strains associated with the change in moisture content of the dry or partially saturated soil. Typically, the coarser the soil, the more flexible the cable needs to be to detect leakage induced strains because the strains associated with the change in moisture content are smaller as the pore sizes increase.

The method may include making use of an already installed fibre-optic cable positioned in the vicinity of the pipeline to be monitored such that a change in the soil moisture content consistent with a leak from the pipeline would induce a change of strain in the fibre-optic cable. Alternatively, the method may include the prior step of installing a fibre-optic cable in the soil in the vicinity of the pipeline to be monitored.

According to another aspect of the invention, there is provided a leak detection arrangement for detecting leakage from a pipeline installed in a substrate which for example includes:

a. a fibre-optic cable positioned in the substrate in the vicinity of the pipeline;
b. a strain monitoring arrangement configured to monitor strain in the fibre-optic cable and to detect localised changes in the monitored strain; and
c. a processor to which the strain monitoring arrangement is connected, and which is configured to determine whether the detected change in the strain is indicative of a leak in the pipeline and to generate a signal in response thereto.

The substrate may be a particulate material, for example, unsaturated soil.

One skilled in the art would recognize that changes in the moisture content and/or the temperature of the soil may induce changes in the strain of the fibre-optic cable. When the change in moisture content is as a result of precipitation then it would be expected that the change would occur over a substantial length of the fibre-optic cable. Similarly, a change in temperature of the soil due to environmental changes, e.g., the time of day and/or seasonal changes would induce a strain along a substantial length of the fibre-optic cable. In contrast, a leak from the pipeline is likely, at least initially to increase the moisture content of the soil in the immediate vicinity of the leak which in turn will cause a localised change in the strain in the fibre-optic cable. The leak detection arrangement is typically configured in order to distinguish between the generalised change in strain arising from natural changes in the moisture content and/or of the temperature of the soil and the localised changes which occur as a consequence of a leak from the pipeline. This process will typically be automated enabling the data from the processor to be interpreted.

The strain may be monitored by an interrogator which is connected to the fibre-optic cable.

The base strain may be a baseline strain profile which is pre-recorded, e.g., which takes into account seasonal temperature changes. The method may include updating the baseline strain profile from time to time in order to take into account the most recently recorded strain profile.

If the signal generated by the processor is indicative of a leak it may be used to activate an alert message, e.g., on an operator's screen, of the potential leak.

### BRIEF DESCRIPTION OF THE DRAWING

The accompanying drawing, which is incorporated in and constitutes a part of the specification, illustrate the embodiment of the disclosure and together with the detailed description herein, serves to explain the principles of the disclosure. It is emphasized that, in accordance with the standard practice in the industry, various features are not drawn to scale. In fact, the dimensions of the various features may be arbitrarily increased or reduced for clarity of discussion. The drawing is only for the purposes of illustrating a preferred embodiment and is not to be construed as limiting the disclosure. The invention will as described, by way of example, with reference to the accompanying diagrammatic drawing which shows a transverse cross-section through a trench in which a pipeline is installed.

FIG. 1 is an elevational view of one embodiment of a pipeline installation in which a leak detection arrangement is shown, in accordance with an aspect of the present disclosure;

### DETAILED DESCRIPTION FOR CARRYING OUT THE INVENTION

The following description of the invention is provided as an enabling teaching of the invention. Those skilled in the relevant art will recognise that many changes can be made to the embodiments described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention. Thus, the following description is provided as illustrative of the principles of the present invention and not a limitation thereof.

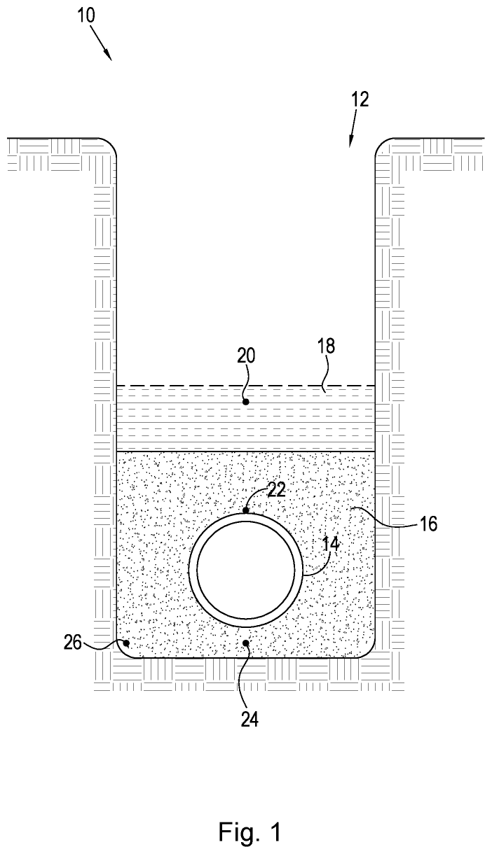

In FIG. 1, reference numeral 10 refers generally to part of a pipeline installation in which a leak detection arrangement in accordance with the invention is being used.

The installation 10 includes a trench 12 and a pipeline 14 which is laid in the trench 12. The pipeline 14 is surrounded by a cradle of compacted selected granular material 16 and a layer of compacted fill 18 is provided on the granular material 16. A fibre-optic cable is laid in the trench 12 adjacent to the pipeline 14. In this regard, reference numerals 20, 22, 24, 26 illustrate various positions at which the fibre-optic cable can be positioned in the trench 12.

It will be appreciated that the specific dimensions of the pipe as well as the trench 12 and positions of the fibre-optic cable can vary. However, in one example, with the installation 10 including a pipeline having a diameter D, the pipeline 14 is positioned a distance X from the bottom of the trench which is typically about D/4. Preferably, the pipeline is positioned between 100 mm and 200 mm from the bottom of the trench. The depth B of the granular material 16 above the pipeline 14 will typically be of the order of 100 mm. the depth A of the compacted fill 18 will typically be of the order of 200 mm.

The leak detection arrangement further includes a strain monitoring arrangement in the form of an interrogator such as that which is available under the tradename “Vision Interrogator” from Omnisens which is connected to an end of the fibre-optic cable. It will be appreciated that any fibre-optic interrogator capable of measuring distributed mechanical and thermal strain in fibre-optic cables or optical fibres could be used. A plurality of interrogators may be connected to a central leakage detection centre. A number of fibre-optic cables, each monitoring a different pipe, may be connected to the interrogator using multiplexing technology. Once the collected data has been processed by the interrogator, it can be transmitted from a laptop computer connected to the interrogator to any user via a computer network or the internet.

It will be appreciated that the fibre-optic cable can be positioned in the trench 12 at the time of laying the pipeline 14. Instead, it may be retrofitted in the ground adjacent to an existing pipeline. In a further embodiment, an existing fibre-optic cable which is positioned in the vicinity of the pipeline, e.g., for telemetry purposes, could be used. It will further be appreciated that although a number of possible positions of the fibre-optic cable are illustrated, the invention is not restricted to these positions and the fibre-optic cable could be at any suitable position in which it is able to detect possible leakage from the pipeline. In addition, the composition of the fill in the trench could vary from that described above.

In use, the interrogator monitors mechanical strain in the fibre-optic cable (20, 22, 24, 26).

The strain monitored by the interrogator is compared with the changes in strain which would reasonably be expected as a consequence of rainfall and/or seasonal changes which result in temperature changes. A localised change in the strain which is indicative of a change in the moisture content of the soil triggers an alert signal which signals to an operator the possibility of a leak.

The leak detection arrangement is able to identify the position at which the change of strain has been identified, permitting the pipeline to be inspected in the vicinity of the change of strain and any remedial action taken in order to address the leak.

The benefits of the disclosed invention will permit the detection of leakage in a cost-effective manner. In addition, the leak detection arrangement will be relatively sensitive when compared with prior art leak protection arrangements thereby permitting leaks to be detected at an early stage. The fact that the fibre-optic cable is free-floating in the pipe trench, (i.e., is not attached to the pipe), facilitates ease of installation and does not require the use of skilled labour.

As may be recognized by those of ordinary skill in the art based on the teachings herein, numerous changes and modifications may be made to the above-described embodiments of the present disclosure without departing from the scope of the disclosure. The components of the leak detection arrangement as disclosed in the specification, including the accompanying abstract and drawing, may be replaced by alternative component(s) or feature(s), such as those disclosed in another embodiment, which serve the same, equivalent or similar purpose as known by those skilled in the art to achieve the same, equivalent or similar results by such alternative component(s) or feature(s) to provide a similar function for the intended purpose.

The terminology used herein is for the purpose of describing the particular embodiment only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or arrangement that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, an arrangement or structure that is configured in a certain way is configured in at least that way, but may also be configured in ways that are not listed.

The disclosure has been described with reference to the preferred embodiments. It will be understood that the architectural and operational embodiments described herein is exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations.

What is claimed is:

1. A method of detecting leakage in a pipeline installed in a substrate, comprising:
monitoring the strain of a fibre-optic cable positioned in the substrate in the vicinity of the pipeline;
detecting a localised change in strain; and
generating an alert signal if the detected change in strain is indicative of a leak from the pipeline.

2. The method of claim 1, further comprising:
comparing the detected change in strain with a base strain; and
generating the alert signal if the difference between the detected strain and the base strain exceeds a predetermined level.

3. The method of claim 2, wherein the base strain is a baseline strain profile which is pre-recorded.

4. The method of claim 3, further comprising:
updating the baseline strain profile periodically in order to evaluate the most recently recorded strain profile.

5. The method of claim 1, wherein the substrate is unsaturated soil.

6. The method of claim 5, further comprising:
making use of an already installed fibre-optic cable positioned in the vicinity of the pipeline to be monitored such that a change in soil moisture content consistent with a leak from the pipeline would induce a change of strain in the fibre-optic cable.

7. The method of claim 1, further comprising:
installing a fibre-optic cable in the substrate in the vicinity of the pipeline to be monitored.

8. A leak detection arrangement for detecting leakage from a pipeline installed in a substrate, the arrangement comprising:
a fibre-optic cable positioned in the substrate in the vicinity of the pipeline;
a strain monitoring arrangement configured to monitor strain in the fibre-optic cable and to detect localised changes in the monitored strain; and
a processor to which the strain monitoring arrangement is connected, wherein the processor is configured to determine whether the detected change in strain is indicative of a leak in the pipeline and to generate a signal in response thereto.

9. The leak detection arrangement of claim 8, wherein the substrate is a particulate material.

10. The leak detection arrangement of claim 8, wherein the substrate is unsaturated soil.

11. The leak detection arrangement of claim 10, wherein the arrangement is configured to distinguish between generalised changes in strain arising from natural changes in the moisture content and/or of the temperature of the soil and localised changes which occur as a consequence of leak from the pipeline.

12. The leak detection arrangement of claim 8, wherein the strain is monitored by an interrogator which is connected to the fibre-optic cable.

13. The leak detection arrangement of claim 12, wherein the processor is configured to compare the strain monitored by the interrogator with a baseline strain profile which is pre-recorded.
